(19) United States
(12) Patent Application Publication
(10) Pub. No.: US 2024/0396325 A1
(43) Pub. Date: Nov. 28, 2024

(54) DISABLE CIRCUIT FOR A CURRENT INRUSH LIMITER

(71) Applicant: TEXAS INSTRUMENTS INCORPORATED, Dallas, TX (US)

(72) Inventor: Abhijeet Godbole, Bangalore (IN)

(21) Appl. No.: 18/450,575

(22) Filed: Aug. 16, 2023

(30) Foreign Application Priority Data
May 26, 2023 (IN) 202341036859

(51) Int. Cl. H02H 9/00; H02H 3/20; H02H 9/02; H02H 9/04

(52) U.S. Cl. CPC H02H 9/002; H02H 3/207; H02H 9/025; H02H 9/046

(57) ABSTRACT

A power control circuit includes a transistor having a first control input and a first current terminal. A controller has a controller output coupled to the first control input. A current inrush limiting circuit has an output and an input coupled to the first control input. A disable circuit has a first input, a sense input, and a supply reference terminal. The first input is coupled to the output of the current inrush limiting circuit. The sense input is coupled to the first current terminal. The disable circuit is configured to: in response to a voltage of the first current terminal being below a threshold, couple the output of the current inrush limiting circuit to the supply reference terminal, and, in response to the voltage of the first current terminal being above the threshold, decouple the output of the current inrush limiting circuit from the supply reference terminal.

### CROSS-REFERENCE TO RELATED APPLICATIONS

This application claims priority to India Provisional Application No. 202341036859, filed May 26, 2023, titled “Novel Circuit for Faster Line Transient Response of Gate Driver in High Inrush Current Controlled Application with Capacitive Loads,” which is hereby incorporated by reference.

### BACKGROUND

It is a common practice to have a capacitor coupled between a power supply input terminal of an electrical load and the supply reference terminal (e.g., ground) to reduce undesirable power supply voltage fluctuations. Such capacitors are initially charged during a power-up event of the system containing such electrical loads. Applying a step voltage to the capacitor can result in a large and thus damaging inrush current to the capacitor.

### SUMMARY

In an example, a power control circuit includes a transistor having a first control input and a first current terminal. A controller has a controller output coupled to the first control input. A current inrush limiting circuit has an input and output. The input of the current inrush limiting circuit is coupled to the first control input. A disable circuit has a first input, a sense input, and a supply reference terminal. The first input of the disable circuit is coupled to the output of the current inrush limiting circuit. The sense input is coupled to the first current terminal. The disable circuit is configured to: in response to a voltage of the first current terminal being below a threshold, couple the output of the current inrush limiting circuit to the supply reference terminal, and, in response to the voltage of the first current terminal being above the threshold, decouple the output of the current inrush limiting circuit from the supply reference terminal.

### BRIEF DESCRIPTION OF THE DRAWINGS

FIG. 1 is a schematic diagram of an example system including fuses to protect against excessive current levels between a battery and electronic units, in an example.

FIG. 2 is a schematic diagram of another example system including a solid-state switch instead of a fuse, in an example.

FIG. 3 of a system including a current inrush limiting circuit, in an example.

FIG. 4 are example waveforms illustrating the operation of the system and current inrush limiting circuit of FIG. 3.

FIG. 5 is a power control circuit including a disable circuit coupled to the current inrush limiting circuit, in an example.

FIG. 6 is a schematic diagram of the disable circuit, in an example.

FIG. 7 is a power control circuit including a disable circuit coupled to the current inrush limiting circuit, in another example.

FIG. 8 is a schematic diagram of the disable circuit of FIG. 7, in an example.

FIG. 9 are example waveforms illustrating the operation of the circuits of FIGS. 6 and 8.

FIG. 10 is an example system including a primary power circuit and an auxiliary power circuit, in an example.

### DETAILED DESCRIPTION

The same reference numbers or other reference designators are used in the drawings to designate the same or similar (either by function and/or structure) features.

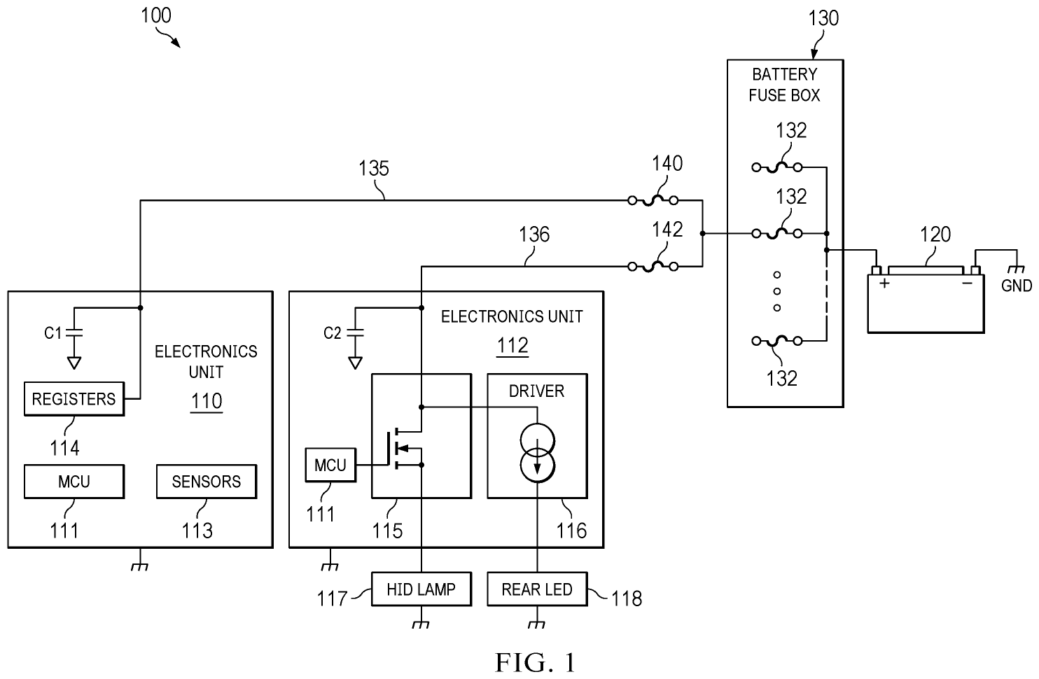

FIG. 1 is a schematic diagram of a system 100 which includes one or more electronics units 110 and 112 coupled to a battery 120. The battery 120 provides an operating voltage and current for each of the electronics units 110 and 112. One or more fuses are coupled between the battery 120 and the electronics units 110 and 112. In FIG. 1, a battery fuse box 130 is included which includes individual fuses 132. An electrical cable couples each electronics unit to the battery fuse box 130. For example, electrical cable 135 couples the battery fuse box 130 to electronics units 110, and electrical cable 136 couples electronics unit 112 to the battery fuse box. A fuse may be included within or coupled to each electrical cable. For example, fuse 140 is associated with electrical cable 135 and electrical unit 110, and current to the electronics unit 110 flows through fuse 140. Similarly, fuse 142 is associated with electrical cable 136 and electrical unit 112, and current to the electronics unit 112 flows through fuse 142. The fuses 132, 140, and 142 in FIG. 1 can be melting fuses in which an excessive current through a fuse overheats the fuse causing the conductor in the fuse to melt and leaving a first portion of the conductor separated from a second portion, which thereby interrupts the flow of current.

A variety of applications are possible for system 100. For example, system 100 may be part of a vehicle (e.g., automobile, truck, bus, airplane, etc.). In the context of an automobile, electronics unit 110 may be an emissions controller and electronics unit 112 may be a body control module. Electronics units 110 and 112 may include a variety of components. For example, electronics unit 110 includes microcontroller unit (MCU) 111, sensors 113, and registers 114. Electronics unit 112 includes an MCU 111, drivers 115 and 116 to turn on and provide current for lights (e.g., light emitting diodes) 117 and 118, respectively. An automobile may include one or more, and typically many, electronics units that receive their operating power from the battery 120.

Each electronics unit also may include a capacitor coupled between its power supply terminal input and a supply reference terminal (e.g., ground). For example, electronics unit 110 includes capacitor C1, and electronics unit 112 includes capacitor C2. As described above, such capacitors reduce ripple on the supply voltage from the battery 120 to the circuitry in each electronics unit. Such capacitors may be relatively large (e.g., 5 mF).

A vehicle may have numerous fuses (e.g., more than 80 fuses) distributed across multiple fuse boxes 130. The electrical cables 135 and 136 should be sized in terms of their thickness (cross-sectional area) to safely conduct the maximum amount of current that a fuse can conduct without melting the fuse. For example, for a fuse rated for 20 amperes (A), the electrical cable should be sized to safely conduct at least up to 20 A of current. However, the current rating of melting fuses has considerable variability. For example, a 20A fuse may not melt until its current reaches 25A. Because of such variability, the electrical cables in a vehicle are generally sized to accommodate more current than the stated current ratings of the fuses. Larger current capacity cables means that the cross-sectional areas of the cables are larger and thus occupy more space in a vehicle, and the cables are also heavier.

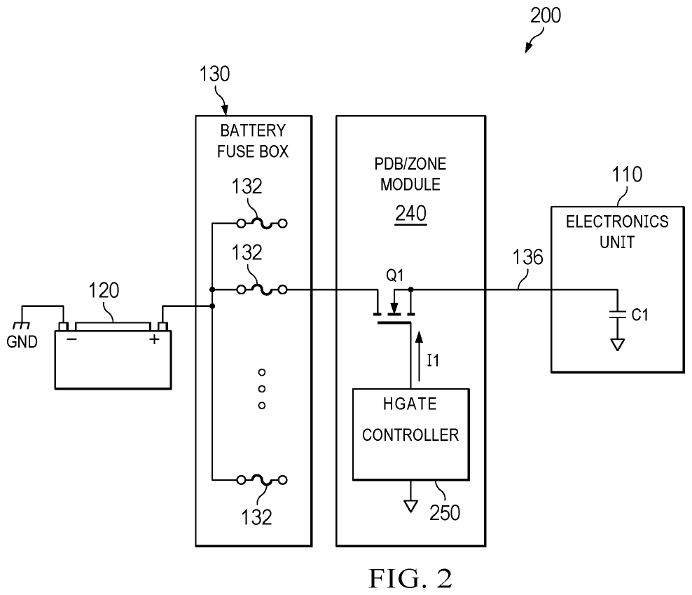

To address the problems described above, one or more of the melting fuses in an automobile can be replaced with a solid-state switch. For example, FIG. 2 is a schematic diagram of a system 200 in which a solid-state transistor, e.g., transistor Q1, is included instead of a melting fuse (e.g., fuse 140 in FIG. 1). Any or all the fuses can be replaced with solid-state switches. The solid-state transistors may be field effect transistors (FETs). A controller 250 is coupled to the control input (e.g., gate) of transistor Q1. The current through transistor Q1 can be precisely monitored by controller 250, and controller 250 can turn off transistor Q1 in response to the current through the transistor exceeding a predefined current (e.g., 20 A). Because there is less variability in the over-current threshold implemented by controller 250 than the current which melts a fuse, the electrical cables coupled between the solid-state switches and the electronics units can use smaller gauge wires than would otherwise have been the case with melting fuses. The solid-state transistors Q1 and their associated controllers 250 may be included as part of a power distribution box/zone module 240 in a vehicle.

While the use of transistors as switches instead of melting fuses allows for smaller and lighter weight cabling to be used in a vehicle, the use of such transistors may create a problem in which the in-rush current through the transistor to charge the capacitor C1 may damage the transistor. For example, with the vehicle off, controller 250 may be off, and if controller 250 is off, transistor Q1 also is off. With transistor Q1 off, capacitor C1 may be discharged. In response to turning the vehicle on, controller 250 turns on transistor Q1. The current to a capacitor is proportional to the rate of change of the voltage across the capacitor with respect to time (capacitor current∝dv/dt). Accordingly, a sudden change in capacitor voltage when transistor Q1 turns on can cause a large enough inrush current to the capacitor that transistor Q1 may be damaged.

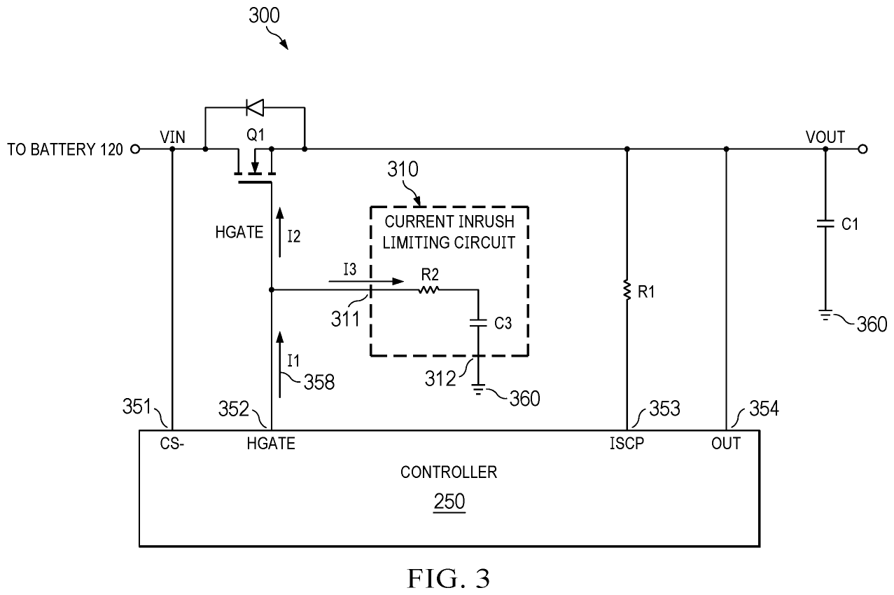

FIG. 3 is a schematic diagram of a power control circuit 300 illustrating a solution to the large inrush current when transistor Q1 is turned on. The power control circuit 300 of FIG. 3 includes transistor Q1, controller 250, and a current inrush limiting circuit 310. The voltage on the drain of transistor Q1 is labeled the input voltage VIN from, for example, a battery (e.g., an automobile battery). The voltage on the source of transistor Q1 is labeled the output voltage (VOUT), which is provided to the electronics unit and its capacitor (e.g., capacitor C1).

In this example, current inrush limiting circuit has an input 311 coupled to the gate of transistor Q1 and an output 312 coupled to the ground reference 360. Current inrush limiting circuit 310 may include a resistor R2 coupled in series with a capacitor C3 between input 311 and thus the gate of transistor Q1 and output 312 and thus the ground reference 360. Controller 250 includes sense inputs 351, 353, and 354 and an output 352. Sense input 351 is coupled to the drain of transistor Q1, and sense input 354 is coupled to the source of transistor Q1. A resistor R1 is coupled between the source of transistor Q1 and sense input 353. Controller output 352 is coupled to the gate of transistor Q1 and to resistor R2.

When controller 250 initiates the turn-on of transistor Q1, controller 250 sources current I1 through its output 352. Current I1 divides between current I2 to the gate capacitance of transistor Q1 and current I3 to the current inrush limiting circuit 310. Current I2 charges the transistor's gate capacitance, and current I3 charges capacitor C3. While capacitor C3 is charging, the rise of voltage (HGATE) on the gate of transistor Q1 is limited due to the time constant implemented by the combination of the resistance of resistor R2 and the capacitance of capacitor C3. By limiting how quickly HGATE can rise, transistor Q1 turns on more slowly compared to what would have occurred absent the current inrush limiting circuit 310. While current inrush limiting circuit 310 causes the magnitude of the inrush current through transistor Q1 to capacitor C1 to be limited, current inrush limiting circuit 310 can cause several problems to occur if a transient is present on the input voltage VIN.

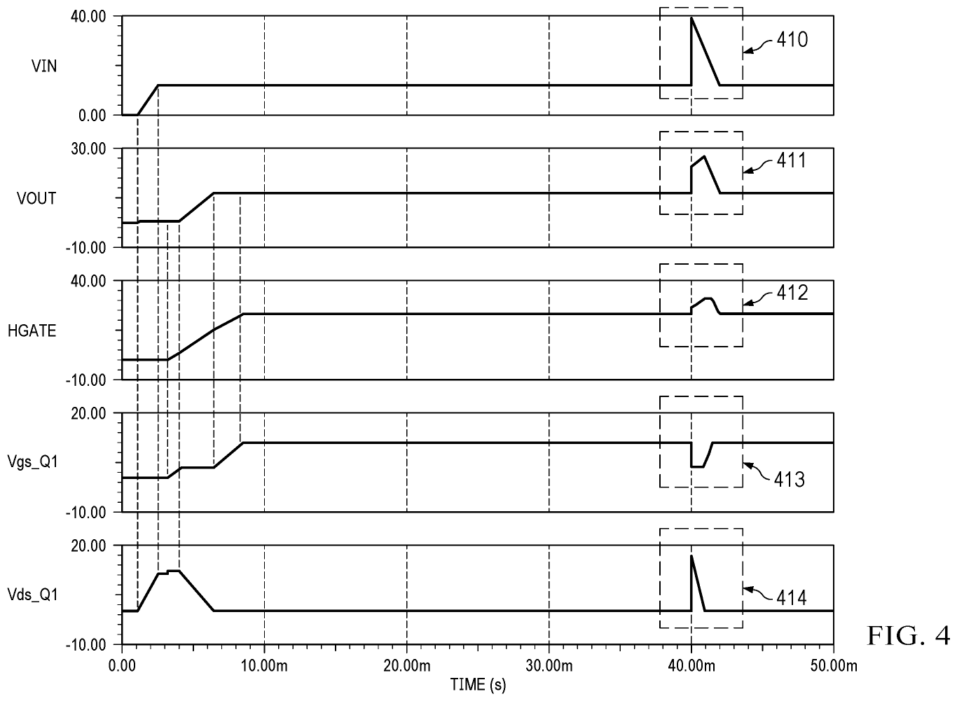

FIG. 4 includes example waveforms illustrating several problems with the current inrush limiting circuit 310. The example waveforms in FIG. 4 include VIN, VOUT, HGATE, the gate-to-source voltage of transistor Q1 (Vgs_Q1), and the drain-to-source voltage of transistor Q1 (Vds_Q1). The VIN waveform illustrates a transient 410 in which VIN increases rapidly from its nominal level (e.g., 12V) to 40V and back to 12V in 1 millisecond (ms). The voltage on the source of transistor Q1 (VOUT) also has a transient 411 that largely tracks the transient 410 of the drain voltage VIN. The gate voltage (HGATE), however, is not able to rise as rapidly as VIN or VOUT due to capacitance C3 of the current inrush limiting circuit 310. Accordingly, HGATE's transient 412 is at a lower slew rate than the transients 410 and 411 of VIN and VOUT. Because the current inrush limiting circuit 310 prevents gate voltage HGATE of transistor Q1 from rising as rapidly as the transistor's source voltage, the Vgs_Q1 decreases as illustrated by transient 413 for Vgs_Q1. One problem a decrease in Vgs_Q1 can cause is that, if Vgs_Q1 drops to the threshold voltage (Vth) of the transistor, transistor Q1 will undesirably turn off thereby turning power off to the electronics unit.

Another problem that can occur due to the presence of current inrush limiting circuit 310 is false trigger of an overcurrent detection capability of controller 250. When transistor Q1 is on and fully enhanced, its on-resistance (Rdson) is at a fairly low and known resistance level (e.g., 100 milliohms). The level of Vds_Q1 is the product of current through transistor Q1 and its on-resistance. The sense inputs 351 and 353 of controller 250 can be coupled to the source and drain (via resistor R1) of transistor Q1. The voltage drop between the sense inputs 351 and 353 is proportional to Vds_Q1 and thus proportional to the current through the transistor. The controller 250 may include a voltage comparator that compares the voltage difference between sense inputs 351 and 353 and an internal reference voltage. If the voltage difference between sense inputs 351 and 353 exceeds the reference voltage (which may occur in response to an over-current condition such as a short-circuit in the electronics unit), controller 250 may cause transistor Q1 to turn off. However, the decrease in Vgs_Q1 at transient 413 causes the Rdson of transistor Q1 to increase. The increase in Rdson of transistor Q1 causes its Vds_Q1 to increase as illustrated at transient 414. Controller 250 undesirably may respond to the positive transient 414 of Vds_Q1 by turning off transistor Q1. That is, the positive transient 414 of Vds_Q1 may cause a false trigger of the overcurrent protection of controller 250.

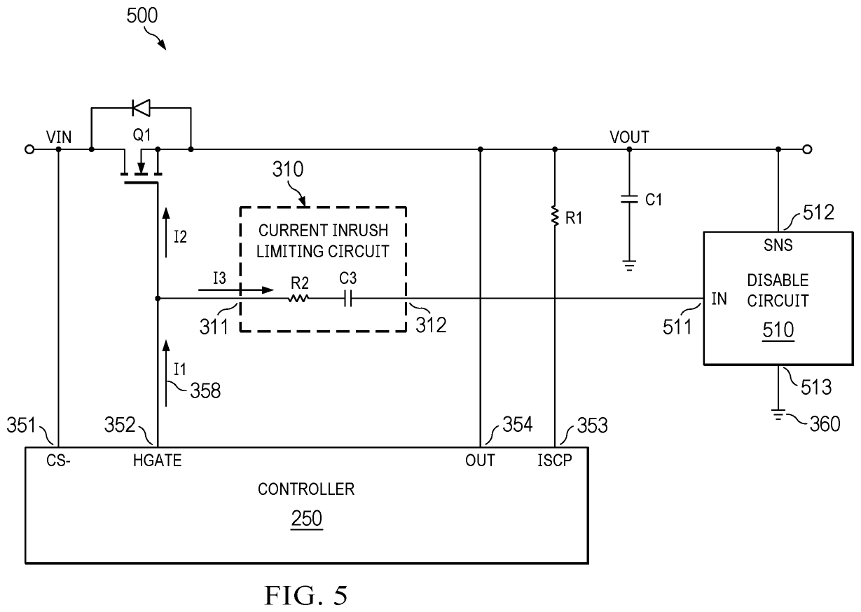

FIG. 5 is a schematic diagram of a power control circuit 500 including transistor Q1, controller 240, current inrush limiting circuit 310, and a disable circuit 510. The inclusion of disable circuit 510 can ameliorate either or both of the above-described problems caused by the current inrush limiting circuit 310 in response to a transient of VIN.

Disable circuit 510 includes a first input 511, a sense input 512, and a ground terminal 513 coupled to the ground reference 360. The output 312 of the current inrush limiting circuit 310 is coupled to the input 511 of the disable circuit 510. Accordingly, the current inrush limiting circuit 310 is coupled between the gate of transistor Q1 and the first input 511 of the disable circuit 510. Accordingly, resistor R2 and capacitor C3 are coupled in series between the gate of transistor Q1 and the first terminal 511. Sense input 512 of the disable circuit 510 receives VOUT. The disable circuit 510 detects whether VOUT is below a threshold or above the threshold. The threshold is less than but close to VIN.

During startup (e.g., as the automobile is turned on), controller 250 begins to turn on transistor Q1, and the current inrush limiting circuit 310 ensures that current I2 to the gate of transistor Q1 is smaller than it would otherwise have been absent the current inrush limiting circuit thereby slowing down the speed at which transistor Q1 fully turns on. As transistor Q1 begins to turn on, VOUT increases from 0V towards the level of VIN (e.g., 12V). In response to detecting that VOUT is less than the threshold, the disable circuit 510 couples first input 511 to ground terminal 511 and thus to the ground reference 360 thereby enabling operation of the current inrush limiting circuit 310 to limit the inrush current to capacitor C1. In response to detecting that VOUT exceeds the threshold (e.g., when capacitor C1 is nearly fully charged), the disable circuit 510 decouples the current inrush limiting circuit 310 thereby disabling the current inrush limiting circuit 310. With the current inrush limiting circuit 310 decoupled from the ground terminal 413 and the ground reference 360, the current path from the gate of transistor Q1 and through resistor R2 and capacitor C3 to the ground reference 360 is disconnected thereby precluding the current inrush limiting circuit 310 from causing either or both of the problems described above.

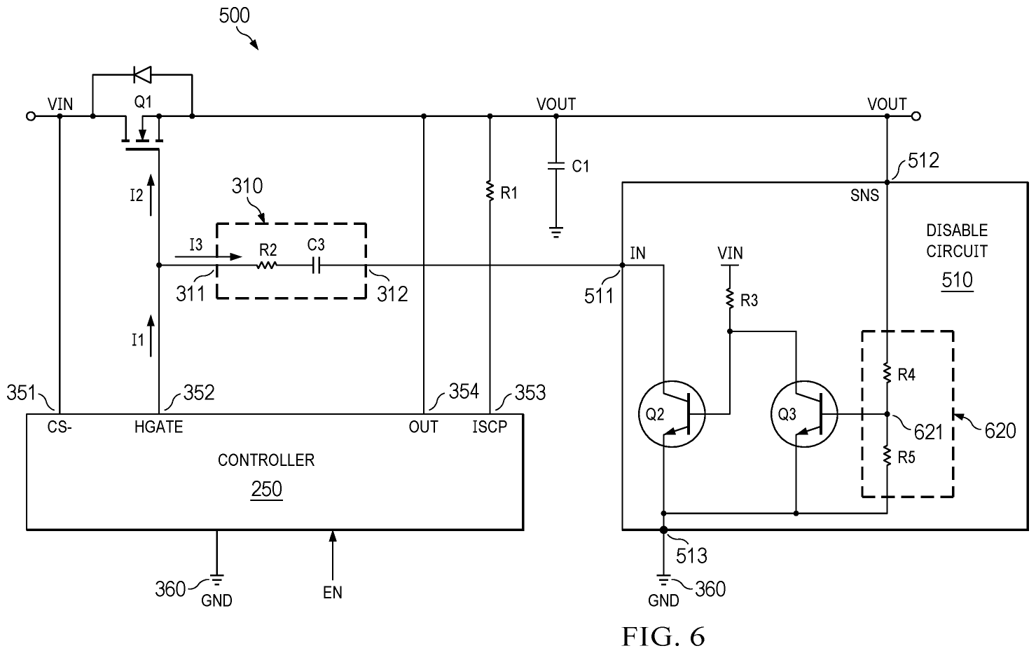

FIG. 6 is a schematic diagram similar to that of FIG. 5 but including an example implementation of the disable circuit 510. In this example, disable circuit 510 includes transistors Q2 and Q3, resistor R3, and a resistor divider 620. Transistors Q3 and Q3 are NPN bipolar junction transistors (BJTs) in this example. The collector transistor Q2 is coupled to the first input 511 and thus to capacitor C3. Resistor R3 is coupled between VIN and the base of transistor Q2 and the collector of transistor Q3. The emitters of transistors Q2 and Q3 are coupled together and to the ground terminal 513. Resistor divider 620 includes resistors R4 and R5 coupled in series between sense input 512 and the ground terminal 513. Although in this example resistor divider 620 includes two resistors R4 and R5, in other examples, resistor divider 620 can include more than two resistors. The connection between resistors R4 and R5 is the output 621 of the resistor divider 620 and is coupled to the base of transistor Q3.

The voltage at output 621 of the resistor divider 620 is based on VOUT and the relative resistance values of resistors R4 and R5. For example,

$$V\_ 621 = VOUT * \frac{R 5}{R 4 + R 5} ,$$

where V_621 is the voltage at output 621. Transistor Q3 is off when its base voltage, V_621, is less than the base-to-emitter voltage (Vbe, e.g., 0.6V) for the transistor. Transistor Q3 is on when its base voltage, V_621, is above, its Vbe. The resistor divider 620 causes transistor Q3 to be off until VOUT becomes close to VIN, at which point the base-to-emitter voltage of transistor Q3 will be high enough to turn on transistor Q3. In an example in which VIN is 12V, the values of resistors R4 and R5 can be chosen such that

$$VOUT * \frac{R 5}{R 4 + R 5}$$

reaches 0.7V when VOUT is approximately 11V. The threshold described above is set based on the values of R4 and R5 and, in one example, is 0.7V.

During start-up, transistor Q3 is off, but transistor Q2 is on due to its base being pulled up to VIN by resistor R3. With transistor Q2 on, the current inrush limiting circuit 310 is enabled and coupled to the ground reference 360. With the current path enabled through the series combination of resistor R2 and capacitor C3 between the gate of transistor Q1 and the ground reference 360, the current inrush limiting circuit 310 is operable to limit the speed at which transistor Q1 turns on thereby limiting the current inrush current to capacitor C1.

In response to VOUT reaching a value close to VIN, V_621 becomes large enough (e.g., 0.7V) to cause transistor Q3 to turn on. With transistor Q3 now on, the base of transistor Q2 is pulled to ground through transistor Q3 thereby turning off transistor Q2. With transistor Q2 off, the current inrush limiting circuit 310 is decoupled from the ground reference 360 thereby turning off the current path from the gate of transistor Q1 through resistor R2 and capacitor C3 to ground. In this state, the current inrush limiting circuit 310 is disabled and does not cause either or both of the problems described above that could otherwise occur during a transient of VIN.

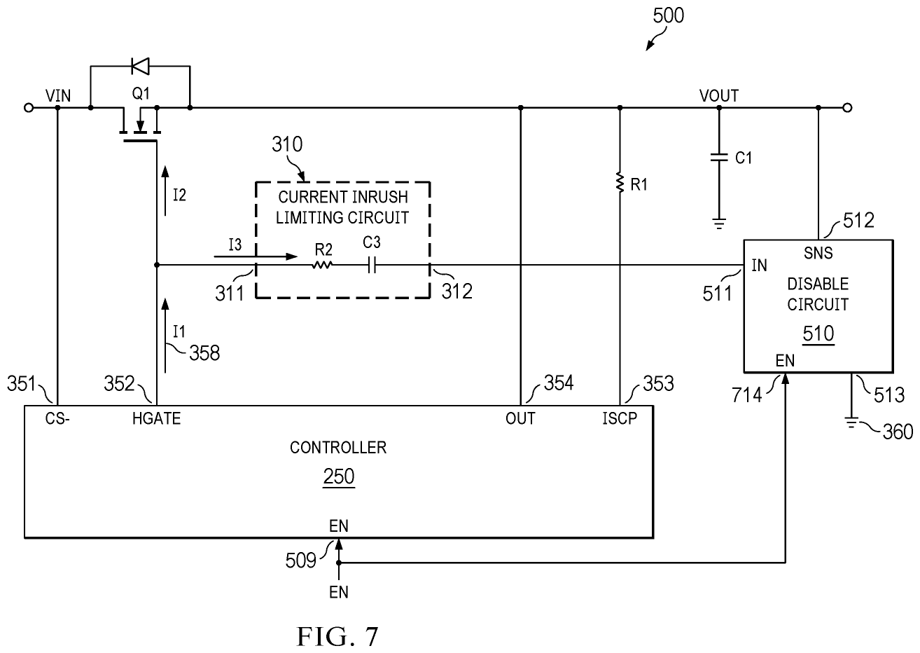

FIG. 7 is a schematic diagram similar to FIG. 6 but having a difference. A difference is that the disable circuit 510 in the example of FIG. 7 includes an enable input 714 which is coupled to an enable input 509 of controller 250. An enable signal (EN) can be provided to enable inputs 509 and 714. In response to the enable signal EN being in a first logic state (e.g., logic 0/low), controller 250 and disable circuit 510 are disabled thereby reducing quiescent current when, for example, the automobile is parked (off). In response to the enable signal EN being in a second logic state (e.g., logic 1/high), controller 250 and disable circuit 510 are enabled thereby causing the controller 250 and disable circuit 510 to perform their functionality as described herein.

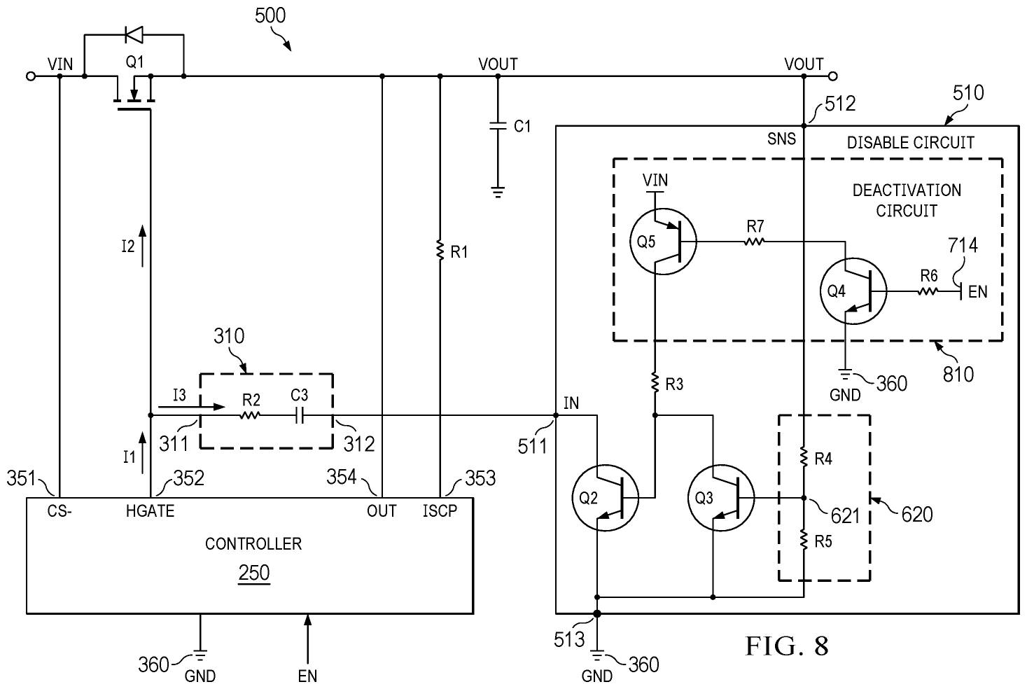

FIG. 8 is a schematic diagram similar to that of FIG. 6 but the disable circuit 510 includes a deactivation circuit 810 to respond to the logic state of the enable signal EN. In this example, deactivation circuit 810 includes transistors Q4 and Q5 and resistors R6 and R7. In this example, transistor Q4 is an NPN BJT, and transistor Q5 is a PNP BJT. The emitter of transistor Q5 is coupled to VIN. Resistor R3 is coupled between the collector of transistor Q5 and the base of transistor Q2 and collector of transistor Q3. Resistor R7 is coupled between the base of transistor Q5 and the collector of transistor Q4. Resistor R6 is coupled between the base of transistor Q4 and enable input 714.

When the enable signal EN is logic high, transistor Q4 is on which pulls the base of transistor Q5 to ground thereby turning on transistor Q5. With transistor Q5 on, disable circuit 510 operates as described above to couple first input 511 to the ground terminal 513 when VOUT is less than the threshold set by resistor divider 620, and to decouple first input 511 from the ground terminal 513 to disable the current limiting circuit 310 when VOUT is greater than the threshold. When the enable signal EN is logic low, transistor Q4 tuns off which causes transistor Q5 to turn off as well. With transistor Q5 off, disable circuit 510 is disabled and consumes very little or no quiescent current.

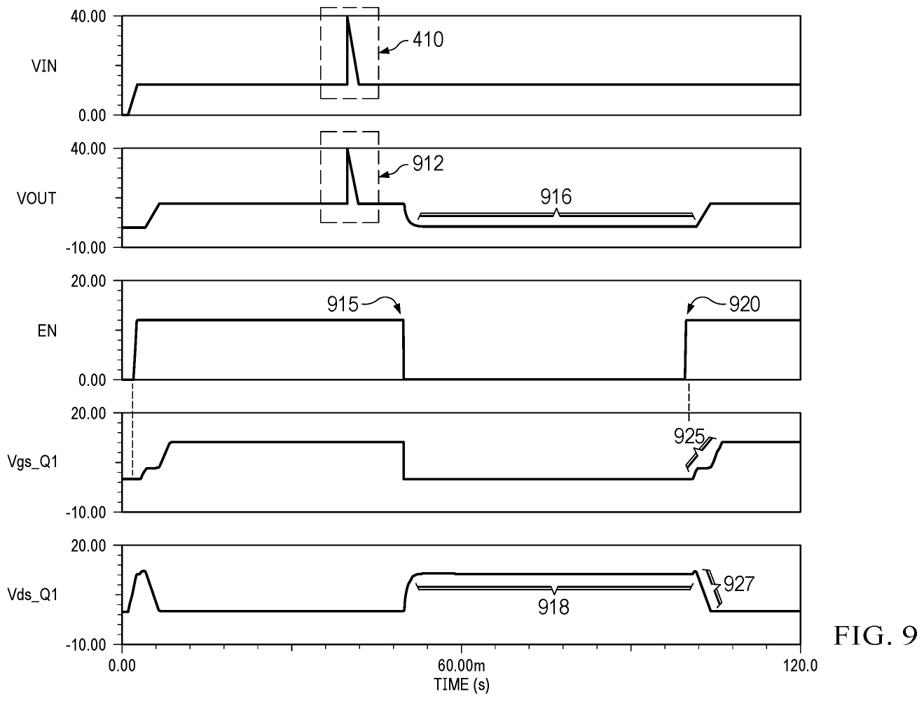

FIG. 9 includes example waveforms illustrating the operation of the disable circuit of FIGS. 6 and 8. The waveforms in FIG. 9 include VIN, VOUT, EN (pertains to FIG. 8, not FIG. 6), Vgs_Q1, and Vds_Q1. In this example, VIN experiences a transient 410, as described above. VOUT responds with a transient 912. During the time that the VIN transient 410 occurs, the enable signal EN is logic high thereby causing disable circuit 510 to be enabled (and disable circuit 510 in FIG. 6 is always enabled). Vgs_Q1 does not experience a downward transient 413 as otherwise was the case in FIG. 4 in the absence of disable circuit 510. Without a droop in Vgs_Q1, transistor Q1 remains and avoids inadvertently turning off, as might have occurred without the disable circuit 510. Further, because Vgs_Q1 does not droop, the on-resistance of transistor Q1 does not substantially increase and thus Vds_Q1 remains relatively constant during the transient 410 of VIN. Because Vds_Q1 does not experience its own transient, the risk of controller 250 falsely detecting an over-current condition and turning off transistor Q1 is substantially lower.

In the example of FIG. 9, the enable signal EN is forced low (915) which might occur, for example, if the automobile is parked. With EN at a logic low state, controller 250 turns off transistor Q1 thereby causing VOUT to fall to 0V (916). The drain voltage of transistor Q1 is VIN and its source voltage is 0V. Accordingly, Vds_Q1 increases to approximately VIN at 918. At 920, the enable signal EN is forced back to the logic high state (e.g., the automobile is transitioned from park to an operating state). Controller 250 responds by forcing current I1 from its output 352 to cause transistor Q1 to turn on. Vgs_Q1 increases (925) in response, and Vds_Q1 decreases (927) as transistor Q1 turns on.

The example disable circuits 510 in FIGS. 6 and 8 include BJTs. In other examples, one or more of the disable circuit's transistors can be field effect transistors (FETs). For example, in FIG. 8, transistors Q2 and Q3 can be BJTs and transistors Q4 and Q5 can be FETs. Alternatively, transistors Q2 and Q3 can be FETs and transistors Q4 and Q5 can be BJTs. In yet another example, transistors Q2-Q5 can be FETs.

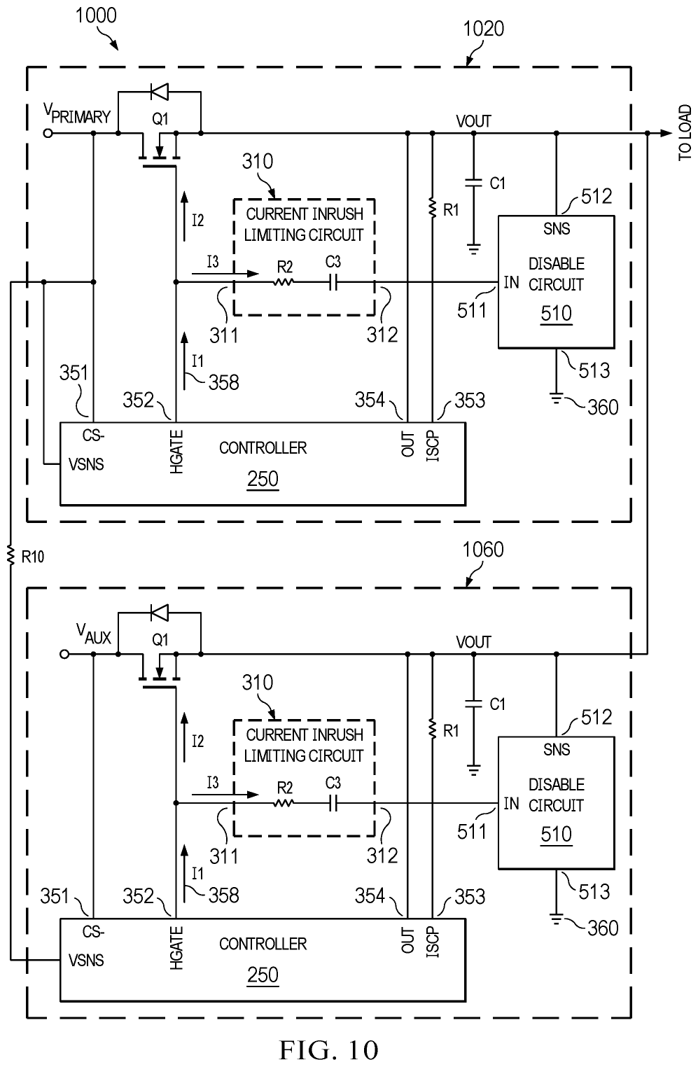

FIG. 10 is a schematic diagram of a system 1000 including a primary power circuit 1020 coupled to an auxiliary power circuit 1060. Each power circuit 1020 and 1060 may be largely the same as shown in FIG. 5. The disable circuit 510 in each of the primary and auxiliary power circuits 1020, 1060 may be implemented as shown in the examples of FIGS. 6 and 8, described above. The inputs to the power circuits 1020, 1060 are coupled to different voltage sources although the magnitude of the voltage sources may be the same. Primary power circuit 1020 receives the primary voltage (V_{PRIMARY}), and auxiliary power circuit 1060 receives an auxiliary voltage (V_{AUX}). The outputs of the primary and auxiliary power circuits 1020, 1060 are coupled together to provide the output voltage (VOUT) to the load.

Each of controllers 250 includes a voltage sense input (VSNS). The VSNS input of the controller 250 of the primary power circuit 1020 is coupled to the primary voltage V_{PRIMARY}, and the VSNS input of the controller 250 of the auxiliary power circuit 1060 is coupled to the auxiliary voltage V_{AUX}. While the primary voltage V_{PRIMARY} is active (e.g., above a threshold), the primary power circuit 1020 supplies output voltage VOUT to the load, and controller 250 responds to sensing the primary voltage by turning off transistor Q1 of the auxiliary power circuit 1060. If the primary voltage V_{PRIMARY} falls below the threshold, the controller 250 of the primary power circuit 1020 turns off transistor Q1 of the primary power circuit, and the controller 250 of the auxiliary power circuit 1060 turns on transistor Q1 of the auxiliary power circuit.

In some examples, a second transistor is coupled in series with transistor Q1 within each of power circuits 1020 and 1060 between the voltage source (e.g., V_{PRIMARY} or V_{AUX}) and the load. For example, such a second transistor can be coupled between the voltage source (e.g., V_{PRIMARY} or V_{AUX}) and the drain of the respective transistor Q1, with the drains of the second transistor and transistor Q1 coupled together. Accordingly, the polarity of the back gate diode of the second transistor is reversed from that of the back gate diode of transistor Q1. Such back-to-back transistors within each power circuit 1020, 1060 help to reduce the risk of feedback current from the primary side to the auxiliary side, or vice versa, if there were to be a voltage difference between V_{PRIMARY} and V_{AUX}. For example, if voltage V_{PRIMARY} was larger than V_{AUX}, the back gate diode of the second transistor in auxiliary power circuit 1060 will be off (as well as the channel of the second transistor being off) thereby blocking any feedback current from VOUT within the primary power circuit 1020 from feeding back to voltage V_{AUX} through the auxiliary power circuit. Similarly, if voltage V_{AUX} is larger than V_{PRIMARY}, the back gate diode of the second transistor in primary power circuit 1020 will be off thereby blocking any feedback current from VOUT within the auxiliary power circuit 1060 from feeding back to voltage V_{PRIMARY}.

Each power circuit 1020, 1060 benefits from including the combination of a current inrush limiting circuit 310 and a disable circuit 510, as described above. Additionally, by the disable circuit 510 disabling the primary power circuit's current inrush limiting circuit 310 as described above, the change-over from the primary power circuit 1020 to the auxiliary power circuit 1060 is faster than would be the case if the current inrush limiting circuit 310 was not disabled.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” or “enabled” means that the conduction channel of the FET is present and drain current may flow through the FET. References herein to a FET being “off” or “disabled” means that the conduction channel is not present so drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A apparatus, comprising:
a transistor having a first control input and a first current terminal;
a controller having a controller output coupled to the first control input;
a current inrush limiting circuit having an input and output, the input of the current inrush limiting circuit coupled to the first control input; and
a disable circuit having a first input, a sense input, and a supply reference terminal, the first input of the disable circuit coupled to the output of the current inrush limiting circuit, the sense input coupled to the first current terminal, and the disable circuit configured to:
in response to a voltage of the first current terminal being below a threshold, couple the output of the current inrush limiting circuit to the supply reference terminal; and
in response to the voltage of the first current terminal being above the threshold, decouple the output of the current inrush limiting circuit from the supply reference terminal.

2. The apparatus of claim 1, wherein the transistor is a first transistor, the disable circuit includes a second transistor coupled between the output of the current inrush limiting circuit and the supply reference terminal, and the disable circuit is configured to:
couple the output of the current inrush limiting circuit to the supply reference terminal by turning on the second transistor; and
decouple the output of the current inrush limiting circuit from the supply reference terminal by turning off the second transistor.

3. The apparatus of claim 2, wherein the disable circuit further comprises:
a resistor divider coupled between the sense input and the supply reference terminal;
a third transistor having a control input coupled to the resistor divider and having a second current terminal coupled to a control input of the second transistor; and
a resistor coupled between a voltage input of the apparatus and the control input of the second transistor.

4. The apparatus of claim 3, further comprising a deactivation circuit having an enable input, the deactivation circuit coupled between the voltage input of the apparatus and the resistor.

5. The apparatus of claim 4, wherein the controller has a controller enable input coupled to the enable input of the deactivation circuit.

6. The apparatus of claim 4, wherein the deactivation circuit includes a fourth transistor coupled between the voltage input of the apparatus and the resistor.

7. The apparatus of claim 1, wherein the current inrush limiting circuit includes a resistor coupled in series with a capacitor between the input and output of the inrush limiting circuit.

8. The apparatus of claim 1, wherein the disable circuit is configured to implement the threshold with hysteresis.

9. The apparatus of claim 1, wherein the transistor is a first transistor, the controller is a first controller, the current inrush limiting circuit is a first current inrush limiting circuit, and the disable circuit is a first disable circuit, and the apparatus further comprises: a second transistor having a second control input and a second current terminal;
a second controller having a second controller output coupled to the second control input;
a second current inrush limiting circuit having a second input and a second output, the second input of the current inrush limiting circuit coupled to the second control input; and
a second disable circuit coupled to the second output, and the second disable circuit having a second sense input and a second supply reference terminal, the second sense input coupled to the second current terminal, and the second disable circuit configured to:
in response to a second voltage of the second current terminal being below a second threshold, couple the second output of the second current inrush limiting circuit to the second supply reference terminal; and
in response to the second voltage of the second current terminal being above the second threshold, decouple the second output of the second current inrush limiting circuit from the second supply reference terminal.

10. A power control circuit, comprising:
a first transistor having a first control input and a first current terminal;
a controller having a controller output coupled to the first control input;
a second transistor having a second control input and second and third current terminals, the third current terminal coupled to a supply reference terminal;
a current inrush limiting circuit having an input and output, the input of the current inrush limiting circuit coupled to the first control input, and the output of the current inrush limiting circuit coupled to the second current terminal;
a first resistor coupled between a voltage input of the power control circuit and the second control input; and
a third transistor having a third control input and a fourth current terminal, the third control input coupled to the first current terminal, and the fourth current terminal coupled to the second control input.

11. The power control circuit of claim 10, further comprising a resistor divider coupled between the first current terminal and the supply reference terminal, the resistor divider having an output coupled to the third control input.

12. The power control circuit of claim 10, further comprising a fourth transistor coupled between the voltage input of the power control circuit and the first resistor.

13. The power control circuit of claim 12, wherein the fourth transistor has a fourth control input, and the power control circuit further comprises:
a fifth transistor having a fifth control input and a fifth current terminal, the fifth control input coupled to an enable input;
a second resistor coupled between the fifth current terminal and the fourth control input.

14. The power control circuit of claim 13, wherein the controller is coupled to the enable input.

15. The power control circuit of claim 10, wherein the current inrush limiting circuit includes a first resistor coupled in series with a capacitor between the input of the current inrush limiting circuit and the output of the current inrush limiting circuit.

16. A circuit, comprising:
a first transistor having a first control input, a first current terminal, and a second current terminal, the second current terminal coupled to a supply reference terminal;
a first resistor coupled between a first voltage input and the first control input; and
a second transistor having a second control input and a third current terminal, the second control input coupled to a second voltage input, and the third current terminal coupled to the first control input.

17. The circuit of claim 16, further comprising a resistor divider coupled between the second voltage input and the supply reference terminal, the resistor divider having an output coupled to the second control input.

18. The circuit of claim 16, further comprising a third transistor coupled between the first voltage input and the first resistor.

19. The circuit of claim 18, wherein the third transistor has a third control input, and the circuit further comprises:
a fourth transistor having a fourth control input and a fourth current terminal, the fourth control input coupled to an enable input;
a second resistor coupled between the fourth current terminal and the third control input.

20. The circuit of claim 16, wherein the second transistor has a fourth current terminal coupled to the supply reference terminal.

21. The circuit of claim 16, further comprising:
a third transistor having a third control input and a fourth current terminal; and
a current inrush limiting circuit having an input and output, the input of the current inrush limiting circuit coupled to the third control input, and the output of the current inrush limiting circuit coupled to the first current terminal.
